(19) United States
(12) Patent Application Publication
(10) Pub. No.: US 2017/0083886 A1
(43) Pub. Date: Mar. 23, 2017

(54) METHODS AND SYSTEMS FOR RECORDING INTERACTIONS WITH A SYSTEM FOR PURCHASING MOBILE PHONES AND OTHER ELECTRONIC DEVICES

(71) Applicant: ecoATM, Inc., San Diego, CA (US)

(72) Inventors: John Edward Silva, San Diego, CA (US); Mark Vincent Bowles, San Diego, CA (US); Jeffrey Ploetner, San Diego, CA (US)

(21) Appl. No.: 15/057,707

(22) Filed: Mar. 1, 2016

Related U.S. Application Data
(60) Provisional application No. 62/221,510, filed on Sep. 21, 2015.

(51) Int. Cl. G06Q 20/18; G06F 17/30; G06Q 20/20

(52) U.S. Cl. CPC G06Q 20/18; G06Q 20/206; G06F 17/30259

(57) ABSTRACT

The present disclosure describes various embodiments of methods and systems for operating a kiosk that is configured to purchase electronic items from a user. One or more cameras on the kiosk record a transaction which is stored as a record on a computer-readable medium. A record is also kept of the times at which events occur such as the user activating a control or button, as well as times when graphical user interface (GUI) screens are presented to the user. The transaction record can be analyzed in real time or at a later date to determine why some transactions are not completed or to improve the user experience with the kiosk.

### TECHNICAL FIELD

The present disclosure is directed generally to methods and systems for recycling mobile phones and other consumer electronic devices and, more particularly, to methods and systems associated with improving customer interaction with kiosks that purchase electronic devices.

### BACKGROUND

Consumer electronic devices, such as mobile phones, laptop computers, notebooks, tablets, MP3 players, etc., are ubiquitous. Currently there are over 6 billion mobile devices in use in the world and this number is growing rapidly. Part of the reason for the rapid growth in the number of mobile phones and other electronic devices is the rapid pace at which these devices evolve, and the increased usage of such devices in developing countries.

As a result of the rapid pace of development, a relatively high percentage of electronic devices are replaced every year as consumers continually upgrade their mobile phones and other electronic devices to obtain the latest features or a better operating plan. According to the U.S. Environmental Protection Agency, consumers in the United States alone dispose of over 370 million mobile phones, PDAs, tablets, and other electronic devices every year. Millions of other outdated or broken mobile phones and other electronic devices are simply tossed into junk drawers or otherwise kept until a suitable disposal solution arises.

Although many electronic device retailers and cell carrier stores now offer mobile phone trade-in or buyback programs, many old mobile phones still end up in landfills or are improperly disassembled and disposed of in developing countries. Mobile phones and similar electronic devices, however, typically contain substances that can be harmful to the environment, such as arsenic, lithium, cadmium, copper, lead, mercury and zinc. If not properly disposed of, these toxic substances can seep into groundwater from decomposing landfills and contaminate the soil with potentiality harmful consequences for humans and the environment.

As an alternative to retailer trade-in or buyback programs, consumers can now recycle and/or sell their used mobile phones and other small electronic devices using self-service kiosks located in malls, retail stores or other publically accessible areas. Such kiosks are operated by ecoATM, Inc., the assignee of the present application, and are disclosed in, for example, U.S. Pat. Nos. 8,463,646; 8,423,404; 8,239,262; 8,200,533; 8,195,511; and 7,881,965, which are commonly owned by ecoATM, Inc. and are incorporated herein by reference in their entireties.

When offering to purchase used mobiles phones and/or other electronic devices from consumers, it can be important to offer the consumer a suitable price or other consideration that will convince the user to complete the transaction. If the price or other incentives are not considered valuable enough, the consumer will usually decline the offer. In the past, an operator of the kiosk might assume that the reason why a transaction was not completed was because the amount offered for a particular device was too low. In fact, there can be a number of other reasons why the user did not complete a transaction. Examples of such reasons include bugs in the software that operates the kiosk or confusing directions that may be given to the user. In the past, these factors were not considered in determining why a transaction was not completed. Therefore, there is a need for a system that can gather more information regarding a proposed transaction so that factors other than the price offered for an item can be considered in order to assess why a transaction was not completed.

### BRIEF DESCRIPTION OF THE DRAWINGS

FIG. 1 is an isometric view of a kiosk configured in accordance with an embodiment of the disclosed technology for recycling mobile phones and/or other electronic devices.

FIG. 2 illustrates a system in which an operator server computer receives a transaction record from a number of remotely located kiosks in accordance with an embodiment of the disclosed technology.

FIG. 3 is a flow diagram of a routine implemented by a processing device in a kiosk to record a transaction while presenting information to a user in accordance with an embodiment of the disclosed technology.

FIG. 4 is a schematic diagram illustrating various components associated with the kiosk of FIG. 1 in accordance with an embodiment of the disclosed technology.

### DETAILED DESCRIPTION

The following disclosure describes various embodiments of systems and methods for conducting transactions to purchase mobile phones and other consumer electronic devices, and for performing other operations associated with electronic device recycling. Embodiments of the methods described herein can be performed by or with consumer-operated kiosks, networked processing devices, retailer-assisted machines, and/or the like. Some embodiments of the present technology, for example, are directed to consumer-operated kiosks that can perform automatic visual and/or electrical inspections of mobile phones and/or other consumer electronic devices that are submitted to the kiosks for sale or recycling.

As described in greater detail below, one or more cameras associated with a kiosk are used to record a video and/or still images of a user conducting a transaction and keep the record on a computer-readable medium in the kiosk. The record is electronically transferred to a remote server computer through a wired or wireless communication link or by copying the record to a portable computer-readable medium. A system operator is able to review the recordings of one or more transactions in order to perform such actions as identifying causes why a user did not complete a transaction. In one embodiment, a video recording of a transaction is time stamped or otherwise synchronized with a record of Graphical User Interface (GUI) screens that were presented to the user during the transaction. The user's actions or facial expressions can be compared with the time at which GUI choices or controls are presented in order to aid in identifying GUI errors or confusing directions. In addition or alternatively, the user's facial expressions or body language can be compared with times at which different offers, advertising or other consideration for a device are presented. In this case, the facial reactions or body language are analyzed to gauge the user's reaction to the offer. In yet another embodiment, a live video stream of a transaction is transmitted to a remote server and a human operator or the server computer running facial recognition or other identification software operating on the server analyzes the video images to identify persons of interest who may be known to perpetrate fraudulent redemptions of devices or deter customers from using the kiosks. If a person of interest is identified in the vicinity of the kiosk, actions can be performed such as placing a call to a security company or law enforcement agency.

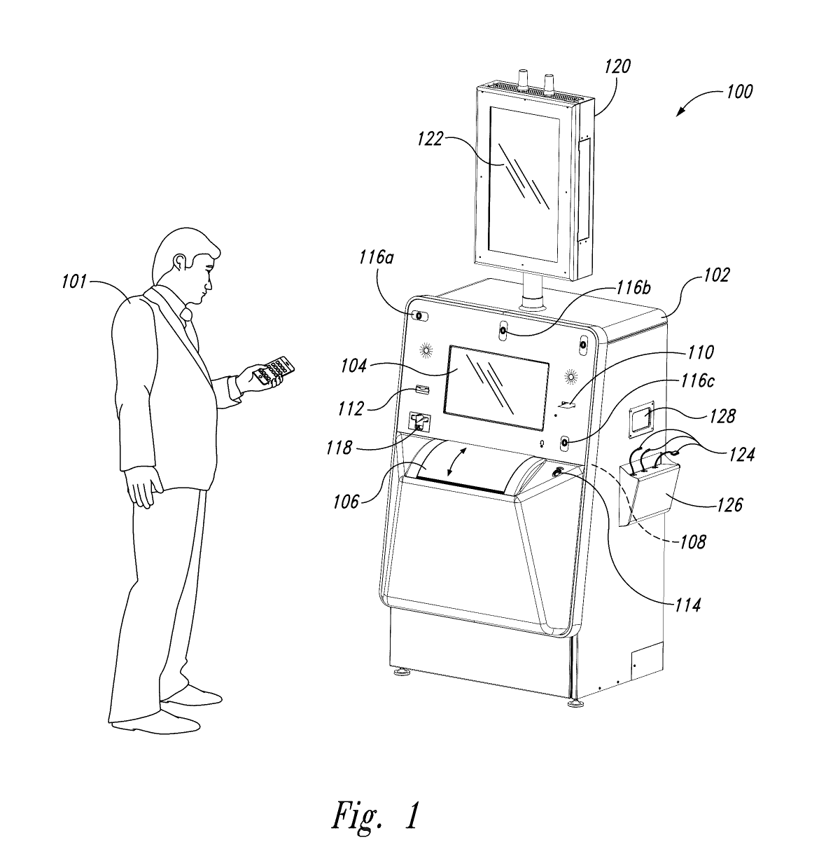

Certain details are set forth in the following description and in FIGS. 1-4 to provide a thorough understanding of various embodiments of the present technology. In other instances, well-known structures, materials, operations and/or systems often associated with smartphones and other handheld devices, consumer electronic devices, consumer operated kiosks, computer hardware, software, and network systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth. The terminology used below should be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as the position of components and certain precise connections between such components when such details are unnecessary for a complete understanding of how to make and use the invention.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view of a kiosk 100 for recycling and/or other processing of mobile phones and other consumer electronic devices in accordance with the present technology. The term “processing” is used herein for ease of reference to generally refer to all manner of services and operations that may be performed or facilitated by the kiosk 100 on, with, or otherwise in relation to, an electronic device. Such services and operations can include, for example, selling, reselling, recycling, donating, exchanging, identifying, evaluating, pricing, auctioning, decommissioning, transferring data from or to, reconfiguring, refurbishing, etc., mobile phones and other electronic devices. Although many embodiments of the present technology are described herein in the context of mobile phones, aspects of the present technology are not limited to mobile phones and generally apply to other consumer electronic devices. Such devices include, as non-limiting examples, all manner of mobile phones, smart phones, handheld devices, PDAs, MP3 players, tablet, notebook and laptop computers, e-readers, cameras, etc. In some embodiments, it is contemplated that the kiosk 100 can facilitate selling and/or otherwise processing larger consumer electronic devices, such as desktop computers, TVs, game consoles, etc., as well smaller electronic devices such as Google Glass™, smart-watches, etc. The kiosk 100 and various features thereof can be at least generally similar in structure and function to the kiosks and corresponding features described in U.S. Pat. Nos. 8,463,646; 8,423,404; 8,239,262; 8,200,533; 8,195,511; and 7,881,965; and in U.S. patent application Ser. Nos. 12/573,089; 12/727,624; 13/113,497; 12/785,465; 13/017,560; 13/438,924; 13/753,539; 13/658,825; 13/733,984; 13/705,252; 13/487,299; 13/492,835; 13/562,292; 13/658,828; 13/693,032; 13/792,030; 13/794,814; 13/794,816; 13/862,395; 13/913,408; 14/498,763; 14/500,739; 62/059,129 and 62/059,132. All of the patents and patent applications listed in the preceding sentence are commonly owned by the applicant of the present application, and they along with any other patents or patent applications identified herein are incorporated herein by reference in their entireties.

In the illustrated embodiment, the kiosk 100 is a floor-standing self-service kiosk configured for use by a user 101 (e.g., a consumer, customer, etc.) to recycle, sell, and/or perform other operations with a mobile phone or other consumer electronic device. In other embodiments, the kiosk 100 can be configured for use on a countertop or a similar raised surface. Although the kiosk 100 is configured for use by consumers, in various embodiments the kiosk 100 and/or various portions thereof can also be used by other operators, such as a retail clerk or kiosk assistant to facilitate the selling or other processing of mobile phones and other electronic devices.

In the illustrated embodiment, the kiosk 100 includes a housing 102 that is approximately the size of a conventional vending machine. The housing 102 can be of conventional manufacture from, for example, sheet metal, plastic, laminated wood panels, etc. A plurality of user interface devices are provided on a front portion of the housing 102 for providing instructions and other information to users, and/or for receiving user inputs and other information from users. For example, the kiosk 100 can include a display screen 104 (e.g., a liquid crystal display (“LCD”) or light emitting diode (“LED”) display screen, a projected display (such as a heads-up display or a head-mounted device), and so on) for providing information, prompts, etc., to users. The display screen 104 can include a touch screen for receiving user input and responses to displayed prompts. In addition or alternatively, the kiosk 100 can include a separate keyboard or keypad for this purpose. The kiosk 100 can also include an ID reader or scanner 112 (e.g., a driver's license scanner), a fingerprint reader 114, and one or more cameras 116 (e.g., digital still and/or video cameras, identified individually as cameras 116a-c). In one embodiment, the cameras include a camera disposed at an eye level of the user and configured to capture images of the user's face, a camera positioned to capture an image of the user's entire body and a camera above the user and configured to capture images of the area around the kiosk. The kiosk 100 can additionally include output devices such as a label printer having an outlet 110, and a cash dispenser having an outlet 118. Although not identified in FIG. 1, the kiosk 100 can further include a speaker and/or a headphone jack for audibly communicating information to users, one or more lights for visually communicating signals or other information to users, a handset or microphone for receiving verbal input from the user, a card reader (e.g., a credit/debit card reader, loyalty card reader, etc.), a receipt or voucher printer and dispenser, as well as other user input and output devices. The input devices can include a touchpad, pointing device such as a mouse, joystick, pen, game pad, motion sensor, scanner, eye direction monitoring system, etc. Additionally the kiosk 100 can also include a bar code reader, QR code reader, bag/package dispenser, a digital signature pad, etc. In the illustrated embodiment, the kiosk 100 additionally includes a header 120 having a display screen 122 for displaying marketing advertisements and/or other video or graphical information to attract users to the kiosk. In addition to the user interface devices described above, the front portion of the housing 102 also includes an access panel or door 106 located directly beneath the display screen 104. In one embodiment, the access door is configured to automatically retract so that the user 101 can place an electronic device (e.g., a mobile phone) in an inspection area 108 for automatic inspection by the kiosk 100.

A sidewall portion of the housing 102 can include a number of conveniences to help users recycle or otherwise process their mobile phones. For example, in the illustrated embodiment the kiosk 100 includes an accessory bin 128 that is configured to receive mobile device accessories that the user wishes to recycle or otherwise dispose of. Additionally, the kiosk 100 can provide a free charging station 126 with a plurality of electrical connectors 124 for charging a wide variety of mobile phones and other consumer electronic devices.

During use, a consumer approaches a kiosk and touches a user interface to begin the process of selling an electronic device. In response to prompts on the display screen 104, the user places the device into the inspection area 108 and connects the device to one of several electronic cables that is appropriate for the device. The device is electronically inspected by the kiosk through the attached cable. In addition, cameras in the inspection area capture images of the device so that its condition can be determined. Once inspected, the consumer is offered a price for the device via, e.g. the display screen 104, that the consumer can either accept or reject. If the offer is accepted, a mechanism in the kiosk moves the device from the inspection area to a collection bin and a voucher is printed or cash is dispensed in the amount of the accepted offer. If the offer is rejected, the consumer can retrieve the device from the inspection area.

As described above, one of the problems associated with operating a kiosk service is trying to determine why consumers may not complete a transaction. A cash offer for a device may be too low or the coupons or discounts offered may not be enticing enough for the user to trade in their electronic device. It has also been discovered that many transactions are not completed because a user is confused about how to operate the kiosk or how to complete all the steps necessary to finalize the transaction. In one embodiment, the prices offered for devices are set from a remote computer system (not shown) that is operated by the kiosk operator. The prices can be dynamically adjusted and compared with transactions that are completed. Thus, it is fairly simple to dynamically adjust the price upwards until a desired or expected number of transactions are completed. What is not so easy to determine is if consumers are not completing transactions because they are confused or frustrated with the operation of the kiosk. Addressing these problems generally involves interviewing users of the system about why they did not complete a transaction. Software updates to the GUI or manner of operating the kiosk are then written and tested on focus groups or other volunteers for feedback. Therefore, the time it takes to determine shortcomings of kiosk operation and to develop improvements is quite slow compared with simply changing the prices offered for different models of electronic components.

To address these problems, the disclosed technology operates to record interactions between the users and the kiosks. The records are then analyzed to determine the point at which the user cancelled the transaction. In some embodiments, the record is synchronized or marked with a timeline indicating when different portions of a GUI or instructions were presented to the user. In some embodiments, the record is synchronized or marked with a timeline showing when different offers or incentives were presented to the user. The transaction records can be viewed in real time or after the transaction is completed/cancelled in order to determine the reasons for cancelling transactions or to improve the users' experience and/or satisfaction with the system.

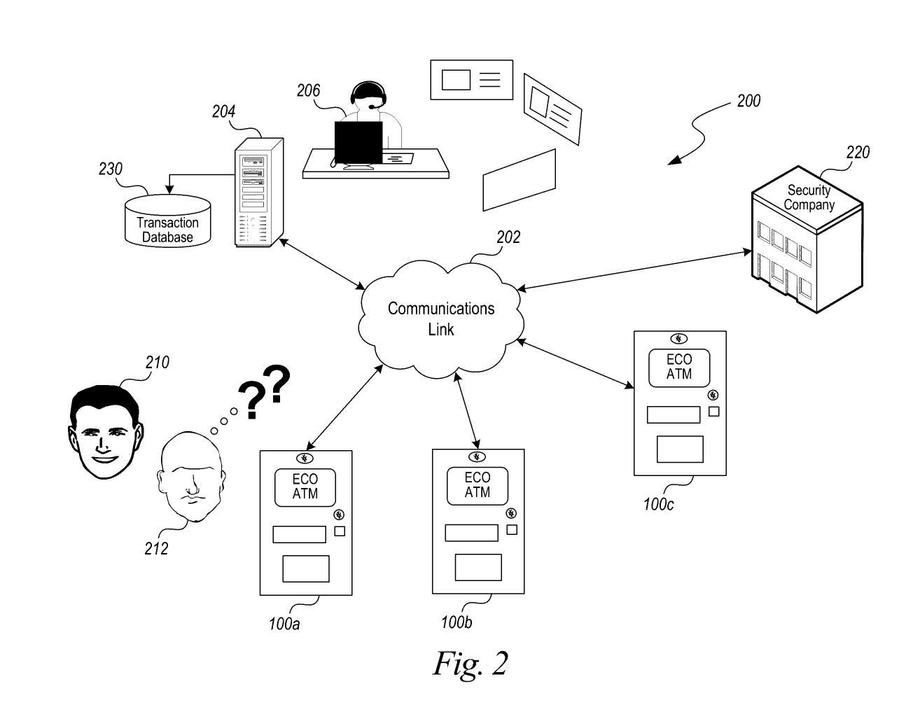

FIG. 2 shows one embodiment of a system 200 for purchasing electronic devices in accordance with an embodiment of the disclosed technology. The system 200 includes a number of kiosks 100a, 100b, 100c etc. that are connected by a wired or wireless computer communication link 202 to a server computer 204 that is operated by the operator of the system. The server computer 204 can receive information and images from the kiosks of devices that users wish to sell. Based on the make and model of the devices and their determined condition, the server computer 204 can send offer amounts for the devices to the respective kiosk. Alternatively, pricing information for various makes/models of electronic devices can be sent a priori to the kiosks for use in purchasing devices.

An operator 206 at the server computer 204 has one or more video monitors with which they are able to view information received from the individual kiosks. For example, a kiosk may ask a user 212 to present some sort of identification and then to look into the kiosk camera. The operator 206 can then confirm the identity of the user by comparing the user's picture with his or her identification. In another embodiment, a user can press a “help” button on the kiosk or GUI and be put in touch with the operator 206 who can answer questions about the device purchasing process. In one embodiment, live video/audio information is recorded by the cameras in the kiosks and transmitted (usually in a compressed form) via the wired or wireless computer communication link 202.

In another embodiment, a live transaction record from the kiosk cameras is fed to the server computer 204 that uses facial recognition or other identification software to detect the presence of persons of interest 210 in the area of the kiosk. Such persons may be persons who have previously attempted to sell stolen electronic devices or have been known to harass users or otherwise interfere with users' operation of the kiosks. If the identification software on the server detects the presence of a person of interest 210, the server can alert the operator 206 who in turn can send a message to a security company 220 or other law enforcement agency to investigate the area around the kiosk. Alternatively, the server computer 204 can be programmed to send a message to the security company 220 when any persons of interest are identified. If the person of interest 210 is attempting to complete a transaction, the server computer or a human operator can send an instruction to the kiosk to terminate the transaction.

As discussed above, one use of the disclosed technology is to determine why some transactions are not completed. To address this, the kiosks keep video or still image records from the various cameras in the kiosk beginning at the time when a user first interacts with the kiosk and ending when a transaction is complete or aborted. In one embodiment, the transaction records are compressed and sent in real time to the server computer 204 that places the records in a database 230 along with an indication of the type of electronic device that the user is attempting to sell. In one embodiment, an event log associated with the transaction record keeps track of when different portions of a GUI are presented to the user. For example, if a user 212 is presented with a list of makes and models of various electronic devices at time 2:39 in a transaction record, then the transaction record can be advanced to 2:39 to see how the user 212 reacts to the list. Similarly, if the user 212 is presented with an offer of $123 for their device at 5:46 in the transaction, then the transaction record can be advanced to time 5:46 to see the user's expression when the offer was presented. In this way, visual (and audio if available and desired) feedback is available to gauge how users react to the operation of the kiosk or to the offers presented. The event log can be searched for the times at which different events occur during the transaction and the transaction record can be used to recall images obtained by the camera(s) at corresponding times. The event log may be a separate file associated with a transaction or the event log may be part of the transaction record, such as metadata etc.

In one embodiment, transaction records are made at kiosks that are located in jurisdictions where only a single party's consent is required to record a conversation. In other embodiments, a user may be asked to give their consent to having the transaction recorded prior to being allowed to use the kiosk. Recording can then begin once the user has provided their consent.

Because the database 230 stores transaction records along with an indication of the type of device that was being offered for sale, an operator (or marketing team) or a computer can analyze the transaction records to determine where the transactions break down for different types of devices. For example, an operator or a computer running facial expression/emotion or gesture detection software can review the images of the transaction to determine if users have a look of disgust or mild bemusement (or perform a gesture indicative of the same emotion) when an offer is presented for a particular make and model of device (suggesting the offer price is too low). If so, the offer amount for that particular type of device can be increased. Conversely, an operator or computer can determine if users who complete transactions show looks of surprise or happiness (or perform gestures indicative of such an emotion) when presented with an offer, discounts, coupons or the like. If so, it may be inferred that the offer amount is too generous and the offer for a particular make or model of equipment can be reduced for future transactions.

In some embodiments, transaction records can be analyzed and compared to times when different features or controls of the GUI are presented to the users. For example, if users often quit using the kiosk when a particular user interface screen is shown, the screen can be reviewed to make sure it is not confusing or is missing some key button/control/instruction, etc. In one embodiment, a video recording of a user's facial expressions are analyzed at the time when a GUI screen is presented. If the user expresses a look of confusion, then the screen can be checked for errors or clarity.

In one embodiment, the operator of the server computer can analyze the transaction records by searching for a time at which a specific event occurs. For example, the operator may want to know when an offer was presented. The operator therefore enters the search terms “Offer Presented” in a search tool and the server computer then searches entries in the event log to determine the time during the transaction when an offer was presented. The server computer can then recall video or still images that were stored in the associated transaction record at the time when the offer was presented.

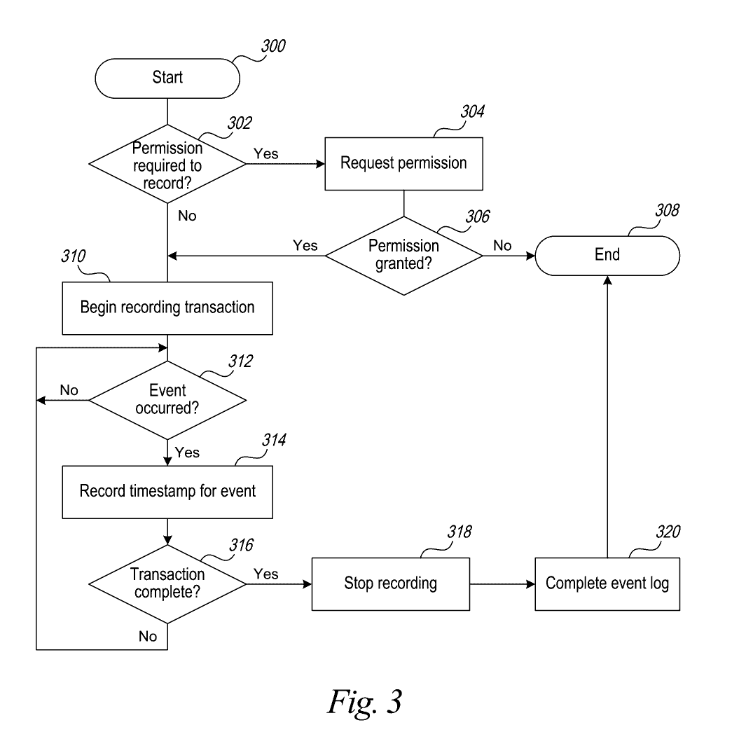

FIG. 3 shows a flow chart of steps performed by a processing device in a kiosk in accordance with one embodiment of the disclosed technology. Although the steps are described in a particular order, it will be appreciated that the steps may be performed in a different order or that different steps may be performed in order to achieve the functionality described.

Beginning at 300, the processing device detects when a user begins interacting with the kiosk. This can be accomplished by detecting an event such the user pressing a button or control on the user interface. Alternatively, proximity sensors on the kiosk can detect when a user approaches the kiosk and the kiosk can present portions of the user interface with, for example, instructions on how to proceed with a transaction.

At 302 the processing device checks to see if the kiosk is located in a jurisdiction where permission of the user is required to record the transaction. If so, the kiosk asks the user for permission to record the transaction at 304. At 306, the processing device determines if permission was obtained. If not, processing ends at 308. If permission is either not required or is obtained, the processing device begins recording the transaction with a series of still or video images from one or more of the cameras at 310.

At 312, the processing device determines if an event has occurred. If not, processing waits until an event does occur. An event may comprise a user activating some control or function on the kiosk including placing an electronic device in the inspection area of the kiosk. Alternatively, an event may occur when the processing device presents some new information (e.g. instructions, an advertisement, images or other item) or aspect of the GUI to the user. When such an event does occur, the processing device records the time and type of event in an event log that is part of or is associated with the transaction record at 314. For example, if the user has indicated that they would like to trade in an Apple iPhone, the processing device may record the time at which the user is shown a screen with different models and asked to select which model they have for sale. Time stamps are recorded when the user selects buttons or images on the user interface. Similarly, the processing device may record a time stamp at the time when the kiosk presents an offer for an item. Each of these time stamps can be searched and used as an index to the images in the transaction record that are obtained from the cameras in order to view the user's reactions to the transaction process.

At 316, the processing device determines if the transaction is complete such as by receiving the device and printing a coupon for the transaction price or by dispensing money. If the transaction is complete, recording stops at 318 and the event log for the transaction is completed or closed at 320.

In one embodiment, the processing device compresses one or more of the transaction recordings and event logs and sends them via the wired or wireless communication link to the server computer of the kiosk operator. In one embodiment, the compression is performed on the video signal that is captured by the camera that obtains images of the area surrounding the kiosk. The compressed video stream can be viewed by operators in real time or by identification software running on the server computer to identify possible security risks that may be occurring at the kiosk. For example, if a known person of interest who has previously attempted to sell stolen phones to the kiosk is seen in the area of the kiosk, then a call can be placed to a security company or law enforcement agency to investigate.

In one embodiment, the processing device in the kiosk is programmed to transfer the transaction recordings and the event logs for the transactions to the server computer. If a high speed communication link is available then such a transfer can take place electronically. However, given the size of the video files and the number of transactions, the processing device can also transfer the data to a portable computer storage medium (e.g. solid state or mechanical hard drive) that is temporarily connected to the kiosk when instructed to do so either by the server computer or by an employee of the kiosk company.

In one embodiment, the server computer is programmed to sort the transaction records and event log files of the transactions by a number of factors such as by different transaction outcomes (e.g. transaction completed, transaction aborted etc.) by type of device that was offered for sale, by geographic region etc. The information in the files can then be used to determine how the offers for various types of electronic devices were received as well as if portions of the GUI or instructions or controls presented are areas in which the user experience can be improved. For example, transactions can be sorted by model number (e.g. 32 Gigabyte iPhone 5) and by outcome (e.g. 23% transactions completed). Therefore it can be determined that the price offered for this model cellular phone may be too low. Also the timestamps of when the offers were presented for this make and model of device can be used to advance the transaction record to the point where an offer was made. Either a human or the server computer running facial expression/emotion or gesture detection software can analyze the corresponding images of the user to gauge the user's reaction to the offer presented. The facial expressions or gestures may give insight into the appropriate offer amount. In another example, if 90% of transactions for Apple iPod mini are not completed and most consumers end the transaction at the time when a particular user interface screen is first presented to the user, then the user screen can be checked for errors, missing instructions or the like. The transaction records and event logs therefore provide a mechanism by which the operation of the kiosk can be tested in a real world environment without having to rely on focus groups or the like to gauge customer reaction to the operation of the system.

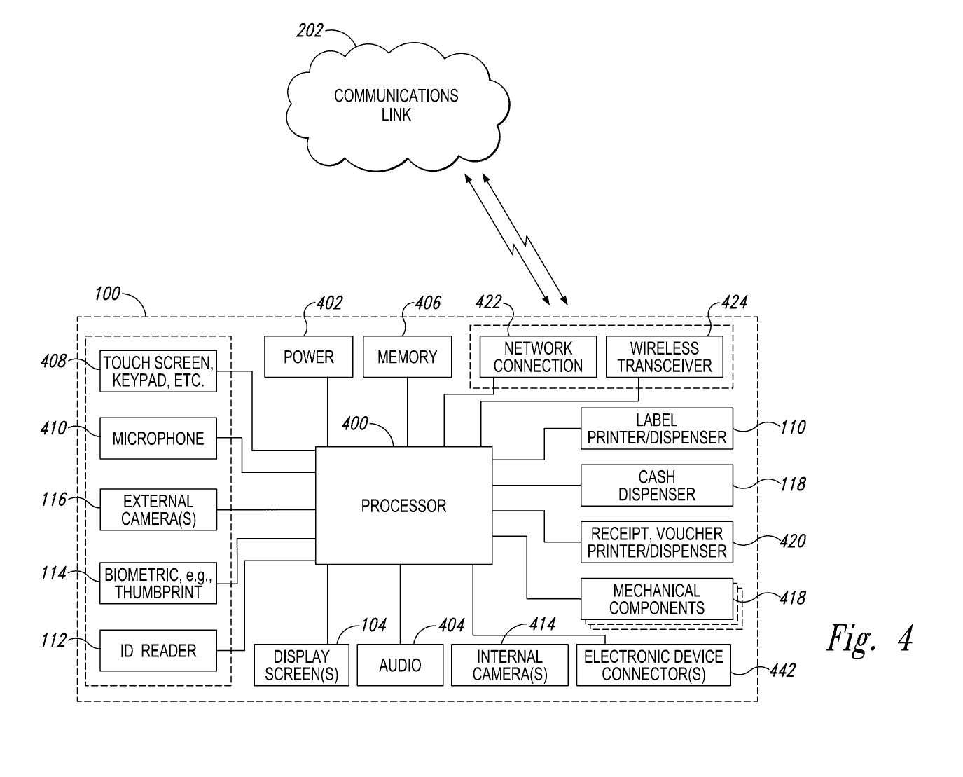

FIG. 4 provides a schematic representation of an architecture of the kiosk 100 in accordance with an embodiment of the present technology. In the illustrated embodiment, the kiosk 100 includes a suitable processing device or central processing unit (“CPU”) 400 that controls operation of the kiosk 100 in accordance with computer-readable instructions stored on system memory 406. The CPU 400, for example, can control performance of the various pricing routines and/or generation of the weighted average prices. The CPU 400 may be any logic processing unit, such as one or more CPUs, digital signal processors (DSPs), application-specific integrated circuits (ASICs), etc. The CPU 400 may be a single processing unit or multiple processing units in a device or distributed across multiple devices. The CPU 400 is connected to the memory 406 and may be coupled to other hardware devices, for example, with the use of a bus (e.g., a PCI Express or Serial ATA bus). The CPU 400 can include, by way of example, a standard personal computer (“PC”) (e.g., a DELL OPTIPLEX 780 or 7010 PC) or other type of embedded computer running any suitable operating system, such as Linux, Windows, Android, iOS, MAC OS, or an embedded real-time operating system. In some embodiments, the CPU 400 can be a small form factor PC with an integrated hard disk drive (“HDD”) or solid-state drive (“SSD”) and universal serial bus (“USB”) or other ports to communicate with the other components of the kiosk 100. In other embodiments, the CPU 400 can include a microprocessor with a standalone motherboard that interfaces with a separate HDD. The memory 406 can include read-only memory (ROM) and random access memory (RAM) or other storage devices, such as disk drives or SSDs, that store the executable applications, test software, databases and other software required to, for example, implement the various routines described herein (e.g., those described with reference to FIG. 3), control kiosk components, process electronic device information and data (to, e.g., evaluate device make, model, condition, pricing, etc.), communicate and exchange data and information with remote computers and other devices, etc.

The CPU 400 can provide information and instructions to kiosk users via the display screen 104 and/or an audio system (e.g., a speaker) 404. The CPU 400 can also receive user inputs via, e.g., a touch screen 408 associated with the display screen 104, a keypad with physical keys, and/or a microphone 410. Additionally, the CPU 400 can receive personal identification and/or biometric information associated with users via the ID reader 112, one or more of the external cameras 116, and/or the fingerprint reader 114. In some embodiments, the CPU 400 can also receive information (such as user identification and/or account information) via a card reader 112 (e.g., a debit, credit, or loyalty card reader having, e.g., a suitable magnetic stripe reader, optical reader, etc.). The CPU 400 can also control operation of the label dispenser 110 and systems for providing remuneration to users, such as the cash dispenser 118 and/or a receipt or voucher printer and an associated dispenser 420.

As noted above, the kiosk 100 additionally includes a number of electronic, optical and electromechanical devices for electrically, visually and/or physically analyzing electronic devices placed therein for recycling. Such systems can include one more internal cameras 414 for visually inspecting electronic devices to, e.g., determine the external dimensions and condition, and one or more of the electrical connectors 442 (e.g., USB connectors) for, e.g., powering up electronic devices and performing electronic analyses. The kiosk 100 further includes a plurality of mechanical components that are electronically actuated for carrying out the various functions of the kiosk 100 during operation. The mechanical components 418 can include, for example, an inspection area access door 106 and one or more of the movable components (e.g. an inspection plate) operably disposed within the inspection area 108 (FIG. 1). The kiosk 100 further includes power 402, which can include battery power and/or facility power for operation of the various electrical components associated with kiosk operation.

In the illustrated embodiment, the kiosk 100 further includes a network connection 422 (e.g., a wired connection, such as an Ethernet port, cable modem, FireWire cable, Lightning connector, USB port, etc.) suitable for communication with, e.g., all manner of remote processing devices via a communication link 202, and a wireless transceiver 424 (e.g., including a Wi-Fi access point, Bluetooth transceiver, near-field communication (NFC) device, and/or wireless modem or cellular radio utilizing GSM, CDMA, 3G and/or 4G technologies) for data communications suitable for communication with, e.g., all manner of remote processing devices via the communication link 202 and/or directly via, e.g., a wireless peer-to-peer connection. For example, the wireless transceiver 424 can facilitate wireless communication with handheld devices, such as a mobile device (e.g., a smartphone) either in the proximity of the kiosk 100 or remote therefrom. By way of example only, in the illustrated embodiment the mobile device can include one or more features, applications and/or other elements commonly found in smartphones and other known mobile devices.

Unless described otherwise, the construction and operation of the various components shown in FIG. 4 are of conventional design. As a result, such components need not be described in further detail herein, as they will be readily understood by those skilled in the relevant art. In other embodiments, the kiosk 100 can include other features that may be different from those described above. In still further embodiments, the kiosk 100 and/or the mobile device 430 can include more or fewer features similar to those described above.

While many of the embodiments are shown and described as being implemented in hardware (e.g., one or more integrated circuits designed specifically for a task), such embodiments could equally be implemented in software and be performed by one or more processors. Such software can be stored on any suitable computer-readable medium, such as microcode stored in a semiconductor chip, on a computer-readable disk, or downloaded from a server and stored locally at a client.

The kiosks 100, server computers 204, user computers and/or other user devices etc. may include one or more central processing units or other logic-processing circuitry, memory, input devices (e.g., keyboards and pointing devices), output devices (e.g., display devices and printers), and storage devices (e.g., magnetic, solid state, fixed and floppy disk drives, optical disk drives, etc.). Such computer devices may include other program modules such as an operating system, one or more application programs (e.g., word processing or spread sheet applications), and the like. Aspects of the invention may be practiced in a variety of other computing environments.

While the communication link 202 is preferably a public network such as the Internet, a private network, such as an intranet may likewise be used herein. The network may have a client-server architecture, in which a computer is dedicated to serving other client computers, or it may have other architectures such as peer-to-peer, in which one or more computers serve simultaneously as servers and clients. A database or databases, coupled to the server computer(s), stores much of the web pages and content exchanged between the user computers. The server computer(s), including the database(s), may employ security measures to inhibit malicious attacks on the system and preserve the integrity of the messages and data stored therein (e.g., firewall systems, message encryption and/or authentication (e.g., using transport layer security (TLS) or secure socket layers (SSL)), password protection schemes, encryption of stored data (e.g., using trusted computing hardware), and the like).

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein, and refer to any of the above devices and systems, as well as any data processor. Input devices may include a touchpad, keyboard and/or a pointing device such as a mouse. Other input devices are possible such as a microphone, joystick, pen, game pad, scanner, digital camera, video camera, and the like. The data storage devices may include any type of computer-readable medium that can store data accessible by a computer, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to a network such as a local area network (LAN), wide area network (WAN) or the Internet.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable medium, including magnetically or optically readable computer discs, hard-wired or preprogrammed chips (e.g., EEPROM semiconductor chips), nanotechnology memory, biological memory, or other data storage media. The data storage devices may include any type of computer-readable medium that can store data accessible by a computer, such as magnetic hard and floppy disk drives, optical disk drives, magnetic cassettes, tape drives, flash memory cards, DVDs, Bernoulli cartridges, RAM, ROMs, smart cards, etc. Indeed, any medium for storing or transmitting computer-readable instructions and data may be employed, including a connection port to a network such as a LAN, WAN, or the Internet. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). The terms “memory” and “computer-readable storage medium” include any combination of temporary, persistent, and/or permanent storage, e.g., ROM, writable memory such as RAM, writable non-volatile memory such as flash memory, hard drives, solid state drives, removable media, and so forth, but do not include a propagating signal per se.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like, are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims. Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A kiosk system for purchasing electronic devices from consumers, the system comprising:
an inspection area for receiving electronic devices;
one or more cameras oriented toward a user of the system;
a processing device; and
a computer-readable medium that contains instructions that when executed cause the processing device to:
identify a type of electronic device that is received in the inspection area;
offer the user a price for the electronic device; and
determine if the user accepts the offer to purchase the electronic device;
wherein the computer-readable medium further contains instructions that when executed cause the processing device to collect images obtained by the one or more cameras to be stored as a transaction record.

2. The system of claim 1 wherein the computer-readable medium further includes instructions that when executed cause the processing device to record a time stamp of when the user activates a control on the kiosk.

3. The system of claim 1 wherein the computer-readable medium further includes instructions that when executed cause the processing device to record a time stamp of when an aspect of a graphical user interface that is presented to a user on a display of the kiosk changes.

4. The system of claim 1 wherein the computer-readable medium further includes instructions that when executed cause the processing device to record a time stamp when the offer is presented to the user.

5. The system of claim 1 wherein the computer-readable medium further includes instructions that when executed cause the processing device to transmit the transaction record to a remotely located computer system.

6. The system of claim 1 wherein the computer-readable medium further includes instructions that when executed cause the processing device to compress images recorded during a transaction and transmit the compressed images to a remote location as the transaction is occurring.

7. The system of claim 1 wherein the computer-readable medium further includes instructions that when executed cause the processing device to record a type of device that the user is attempting to sell in the transaction record.

8. The system of claim 1 wherein the computer-readable medium further includes instructions that when executed cause the processing device to record images from multiple cameras in the transaction record.

9. A system for analyzing transaction records obtained from kiosks that purchase electronic devices from consumers, the system comprising:
a computer-readable medium for storing instructions that are executable by a processing device;
one or more processing devices that execute the instructions to:
receive a transaction record including a number of images and an event log from a remotely located kiosk;
open the event log for the transaction record that records a time at which different events occur during the transaction;
receive a request to recall images associated with an event that occurred during the transaction;
search the event log for a time at which the requested event occurred during the transaction; and
recall images from the transaction record of a user in the transaction that were obtained at the time of the requested event.

10. The system of claim 9, where the computer-readable medium includes instructions that are executable by the one or more processing devices to change a price to be offered for an electronic device based on an analysis of images obtained from one or more received transaction records.

11. The system of claim 10, wherein the analysis of the images obtained from a transaction record is emotion recognition.

12. The system of claim 10, wherein the analysis of the images obtained from a transaction record is gesture recognition.

13. A system for analyzing transaction records obtained from kiosks that purchase electronic devices from consumers, the system comprising:
a computer-readable medium for storing instructions that are executable by a processing device;
one or more processing devices configured to execute the instructions to:
receive a number of transaction records from kiosks that include images captured when users interact with the kiosks to sell electronic devices;
retrieve the images of users in the transaction records at a point when the users are presented with an offer to purchase an electronic device; and
modify prices offered for electronic devices in future transactions based at least in part on an analysis of the images in the received transaction records at a time when offers are presented.

14. The system of claim 13, wherein the transaction records include event logs that specify times at which a user is presented with an offer to purchase an electronic device and wherein the one or more processing devices are configured to execute instructions to search the event log for a time at which a user is presented with an offer and to retrieve images from a transaction record that are captured at the times when the offer is presented.

15. The system of claim 14, wherein the one or more processing devices are configured to execute instructions to determine if a number of completed transactions for a particular type of electronic device is below a threshold and if so, to receive transaction records for a number of attempted transactions in which a user is offering to sell the particular type of electronic device.

16. A system for analyzing transaction records obtained from kiosks that purchase electronic devices from consumers, the system comprising:
a computer-readable medium for storing instructions that are executable by a processing device;
one or more processing devices configured to execute the instructions to:
receive a number of transaction records from kiosks that include images captured when users interact with the kiosks to sell electronic devices and an event log that records when screens of a user interface are shown to the user during a transaction;
retrieve images of users in the transaction records at a point when the users are presented with different screens in a user interface of the kiosk; and
transmit instructions that update the user interface at the kiosks for use in future transactions based at least in part on an analysis of the images in the transaction records.

17. A system for analyzing transaction records obtained from kiosks that purchase electronic devices from consumers, the system comprising:
a computer-readable medium for storing instructions that are executable by a processing device;
one or more processing devices configured to execute the instructions to:
receive a transaction record from a kiosk that includes images captured when a user is interacting with the kiosk to sell an electronic device;
retrieve images from the kiosk to identify persons who are not allowed to conduct business with the kiosk.

18. The system of claim 17, wherein the one or more processing devices are configured to execute instructions to halt a transaction when a person who is not allowed to conduct business with the kiosk is identified.

19. The system of claim 17, wherein the one or more processing devices are configured to execute instructions to alert a third party when a person who is not allowed to conduct business with the kiosk is identified.

20. The system of claim 19, wherein the third party is one or a security company or the police.
